(19) United States
(12) Patent Application Publication
(10) Pub. No.: US 2007/0067581 A1
(43) Pub. Date: Mar. 22, 2007

(54) Method for storing and running application program in flash-rom

(76) Inventor: Jo Heum Baek, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/545,771

(22) PCT Filed: Mar. 24, 2004
(86) PCT No.: PCT/KR04/00650

§ 371 Date: Aug. 7, 2006

(30) Foreign Application Priority Data
Mar. 25, 2003 (KR) 10-2003-0018547

(51) Int. Cl. G06F 12/00; G06F 9/00

(52) U.S. Cl. 711/153; 713/2; 711/103

(57) ABSTRACT

A method for storing and executing an application program in a flash ROM, wherein the flash ROM is partitioned into two regions. One region is used for an operating System (OS) booting ROM and the other region is used for storing an application program. A board of a System boots with the OS booting ROM to execute the application program. This is accomplished by copying the application program to a memory without downloading it from an upper-level layer in hierarchy. Upon modifying the application program, the region of the flash ROM storing the application program is remotely updated with an application program being currently executed an the upper-level layer. Upon modification of the OS booting ROM, it is remotely updated. The method comprises the steps of: initializing hardware drivers; operating a loader and verifying version and checksum of a first application program; verifying version and checksum of a second application program; comparing the first application program with the second application program, copying the first application program to a memory in case the first and second application programs are identical to each other, and executing the first application program; and requesting a download of the second application program in case the first and second application programs are different from each other, storing the downloaded second application program in the flash ROM, and executing the second application program.

### TECHNICAL FIELD

The present invention generally relates to a method for storing and executing an application program in a flash read-only-memory (ROM), and more particularly to a method for storing and executing an application program in a flash ROM, wherein the flash ROM is partitioned into two regions. One region is used for an operating system (OS) booting ROM and the other region is used for storing the application program. A board of a system boots with the OS booting ROM to execute the application program by copying such program to a memory without downloading it from an upper-level layer in the hierarchy. Upon modifying the application program, the region of the flash ROM storing the application program is remotely updated with an application program being currently executed on the upper-level layer. Upon modification of the OS booting ROM, it is remotely updated.

### BACKGROUND ART

Referring now to FIG. 1, there is shown a block diagram of a conventional Code Division Multiple Access (CDMA) 2000-1X system. As can be seen from that figure, the CDMA200-1X system comprises a mobile station (MS) 100, a base transceiver station (BTS) 200, a base station controller (BSC) 300, a base station manager (BSM) 400 and a local exchange (LE) 500.

As further shown in FIG. 1, the BTS 200 comprises a BTS control processor (BCP) 201 and a channel element (CE) 202. The BSC 300 comprises a call control processor (CCP) 301 and a transcoder and selector bank (TSB) 302.

The conventional CDMA2000-1X system performs data communication through a V5.2 protocol. The CCP 301 and the LE 500 discriminate subscribers with reference to an interface and a port, respectively.

The conventional CDMA2000-1X system employs the use of a flash ROM for storing a program directed to booting a system. The conventional CDMA2000-1X system downloads an operating system (OS) with a booter and re-downloads an application program upon executing the OS.

Alternatively, the conventional CDMA2000-1X system employing the use of the flash ROM boots directly with an OS booting ROM which is embedded in the flash ROM in order to download the application program. Therefore, upon being initialized or forced-reset, an upper layer of the CDMA2000-1X system downloads the OS from a server and loads it on a lower layer.

Consequently, a conventional method for storing and executing an application program for use in a CDMA2000-1X system boots such system with a flash ROM to download an OS or application program. Alternatively, the conventional method boots the CDMA2000-1X system through an OS embedded in a flash ROM in order to download an application program. Thereafter, the method initializes and operates the hardware of the CDMA2000-1X system. This inevitably results in a very time consuming task of resetting and initializing the CDMA2000-1X system.

Further, the method boots the upper-level layer of the CDMA2000-1X system by the OS and then loads the application program to the lower-level layer. As such, controlling and debugging the lower-level layer become very dependent on the operation of the upper-level layer. To address and solve such deficiency, there is proposed a method for operating the hierarchy hardware independently through using an OS and an application program that are embedded in a flash ROM. However, it is very difficult to maintain the OS and the application program in the flash ROM. Further, it is not possible to modify the application program without changing the flash ROM to be booted when the OS and/or application program becomes modified.

### DISCLOSURE OF THE INVENTION

Therefore, the primary objective of the present invention is to provide a method for: partitioning a flash ROM into two regions, wherein one region is used for a booting ROM and the other region is used for storing an application program; embedding an operating system (OS) and hardware drivers in the booting ROM; storing the application program on the partitioned region (i.e., region used for storing an application program) other than the region of the booting ROM; booting the system with the booting ROM to execute the OS and the hardware drivers; copying the application program stored in the flash ROM to a memory; and calling the application program from the memory to execute it.

In accordance with the present invention, there is provided a method for: partitioning a flash ROM into two regions, wherein one region is used for an OS booting ROM and the other region is used for storing an application program; booting a board of a system with the OS booting ROM to execute the application program by copying such program to a memory without downloading it from an upper-level layer in the hierarchy; upon modifying the application program, remotely updating the region of the flash ROM storing the application program that is remotely updated with the new application program; and remotely updating the OS booting ROM.

Upon modifying the application program or the OS booting ROM, remotely updating a corresponding region of the flash ROM through downloading a modified program from a board or server in the hierarchy.

The foregoing and other objectives and features of the present invention will become more fully apparent from the following description, appended claims and their accompanying drawings.

### BRIEF DESCRIPTION OF DRAWINGS

These drawings depict only the preferred embodiments of the present invention and should not be considered as limitations of its scope. These as well as other features of the present invention will become more apparent upon reference to the drawings wherein:

FIG. 1 illustrates a block diagram of a conventional Code Division Multiple Access (CDMA) 2000-1X system;

FIG. 2 illustrates a flow chart of a method for storing and executing an application program in a flash read-only-memory (ROM) in accordance with a first preferred embodiment of the present invention; and

FIG. 3 illustrates a flow chart of a method for storing and executing an application program in a flash ROM in accordance with a second preferred embodiment of the present invention.

### BEST MODE FOR CARRYING OUT THE INVENTION

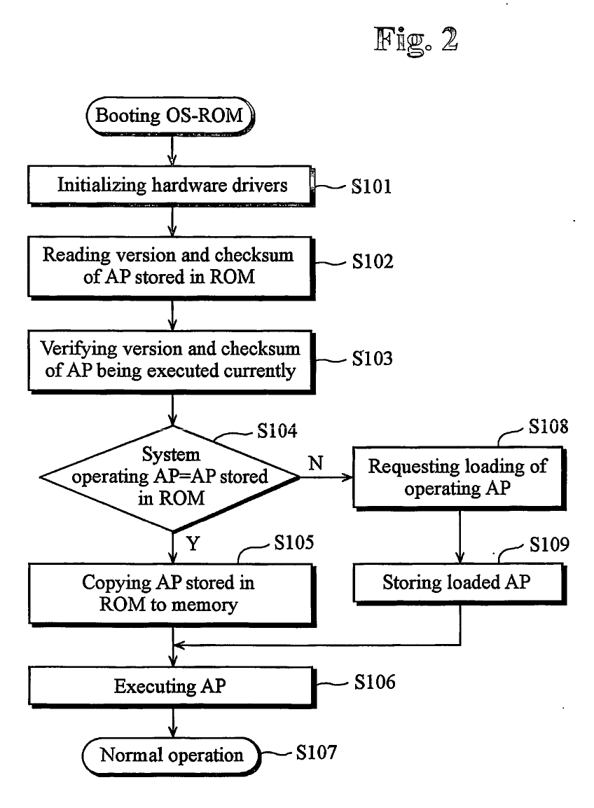

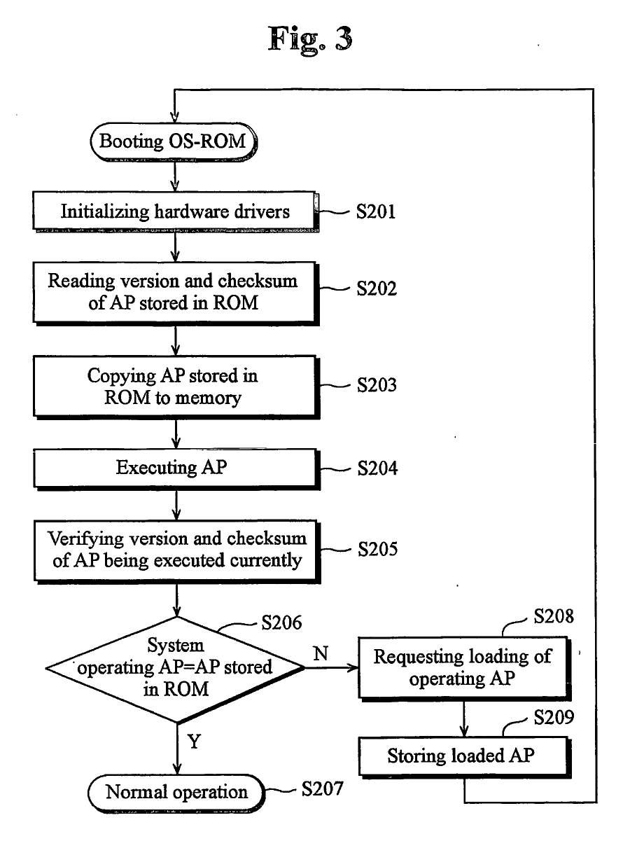

It will be readily understood that the components and steps of the present invention, as generally described and illustrated herein and in the accompanying Figures, may be arranged and designed in a wide variety of different configurations while still utilizing the inventive concept of the present invention. Thus, the detailed description of the preferred embodiments of the present invention, as described and illustrated herein and in FIGS. 2 and 3, is not intended to limit the scope of the present invention. It is merely representative of the preferred embodiments of the present invention. The preferred embodiments of the present invention will be best understood by reference to the Figures, wherein certain parts or steps described herein are designated by their corresponding numerals throughout the Figures.

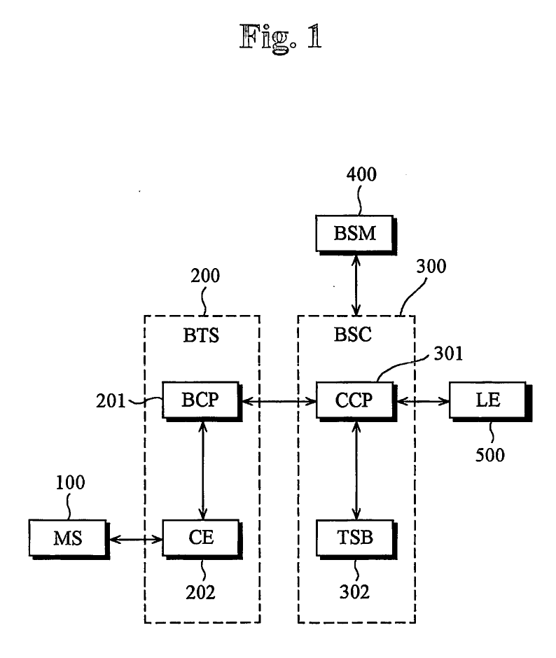

The method of the present invention applies or utilizes a network of CDMA2000-1X systems illustrated in FIG. 1. The method of the present invention comprises the following general steps: partitioning a flash ROM into two regions, wherein one region is used for a booting ROM and the other region is used for storing an application program; embedding an operating system (OS) and hardware drivers in the booting ROM; storing an application program on the partitioned region other than the region of the booting ROM; booting the system with the booting ROM to execute the OS and hardware drivers; copying the application program stored in the flash ROM to a memory; and calling the application program from the memory to execute it.

The preferred embodiments of the present invention are described below.

Referring to FIG. 2, there is shown a flow chart illustrating a method for storing and executing an application program in a flash ROM in accordance with a first preferred embodiment of the present invention. As shown in FIG. 2, hardware drivers are initialized after performing an OS ROM booting (step S101). A loader for downloading application program(s) from an upper-level layer in the hierarchy is provided. The loader is operated to verify version and checksum of an application program (hereinafter referred to as “a first application program”) stored in the flash ROM (step S102). Version and checksum of an application program (hereinafter referred to as “a second application program”) that are currently executed on the upper-level layer are verified (step S103). The first and second application programs are compared with each other. The first application program is copied to a memory to be executed in case the first and second application programs are identical to each other (steps S104˜106). A request to download the second application program is made to the upper-level layer in case the first and second application programs are different from each other. The second application program downloaded from the upper-level layer is stored in the flash ROM so as to be ultimately executed (steps S108˜S109).

More specifically, the hardware drivers are initialized at step S101 after performing the OS ROM booting. At step S102, a loader is operated to verify the version and checksum of the first application program stored in the flash ROM. As mentioned before, the loader downloads the application program(s) from the upper-level layer in the hierarchy, if required and necessary.

At step S103, the version and checksum of the second application program currently executed on the upper-level layer are verified. At step S104, the first and second application programs are compared with each other.

If the first and second application programs are identical to each other, the first application program is copied to a memory at step S105. It is then executed at step S106. Thereafter, the procedure in accordance with the preferred embodiment of the present invention performs a normal operation at step S107.

On the other hand, if the first and second application programs are different from each other, then a request is made to the upper-level layer at step S108 in order to download the second application program. At step S109, the second application program downloaded from the upper-level layer is stored in the flash ROM. Then, the inventive procedure proceeds to step S106 to execute the downloaded second application program.

Referring to FIG. 3, there is shown a flow chart illustrating a method for storing and executing an application program in a flash ROM in accordance with a second preferred embodiment of the present invention. As shown in FIG. 3, hardware drivers are initialized after performing an OS ROM booting (step S201). Version and checksum of an application program (hereinafter referred to as “a first application program”) stored in the flash ROM are read (step S202). The first application program stored in the flash ROM is copied to a memory (step S203). Then, the first application program copied to the memory is executed (step S204). Version and checksum of an application program (hereinafter referred to as “a second application program”), which is currently executed on an upper-level layer in the hierarchy, are verified (step S205). The first and second application programs are compared with each other (step S206). If the first and second application programs are identical to each other, then the procedure of the present invention performs a normal operation (step S207). If they are different, however, then the procedure of the present invention makes a request to the upper-level layer in order to download the second application program (S208). It then stores the downloaded second application program in the flash ROM (S209) and ultimately reboots the OS ROM thereafter.

More particularly, the hardware drivers are initialized at step S201 after performing an OS ROM booting. At step S202, the version and checksum of the first application program stored in the flash ROM are read. At step S203, the first application program stored in the flash ROM is copied to a memory.

At step S204, the first application program copied to the memory is executed. At step S205, the version and checksum of the second application program currently executed on the upper-level layer in the hierarchy are verified.

At step S206, the first and second application programs are compared with each other. If the second and first application programs are identical to each other, then the procedure of the present invention proceeds to step S207 in order to perform a normal operation.

However, if the first and second application programs are different from each other, then the procedure of the present invention requests the upper-level layer at step S208 to download the second application program. At step S209, the procedure of the present invention stores the downloaded second application program in the flash ROM so as to reboot the OS ROM thereafter.

### INDUSTRIAL APPLICABILITY

In accordance with the present invention, the flash ROM in the system is partitioned into two regions, wherein one region is used for an OS booting ROM and the other region is used for storing an application program. The system boots utilizing the OS booting ROM without the need for loading an additional program. It copies the application program stored in the flash ROM to a memory and then executes such program. This enables the system to effectively reduce the initialization time.

Furthermore, in accordance with the present invention, the application program and the OS booting ROM may be modified independently from each other so as to facilitate the maintenance of the system.

Moreover, in accordance with the present invention, it is possible to develop a board and to construct a testing environment without configuring the system.

Additionally, in accordance with the present invention, the upper-level layer in the hierarchy does not need to contain all the application programs that are contained in the lower-level layer. This certainly provides an advantage of reducing the memory resource and the load of downloaded application programs.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

1. A method for storing and executing an application program in a flash read-only-memory (ROM), comprising the steps of:
initializing hardware drivers after booting an operating system (OS) stored in one of two partitioned regions of the flash ROM;
operating a loader configured to download application program(s) from an upper-level layer in hierarchy;
verifying version and checksum of a first application program stored in the other region of the two partitioned regions;
verifying version and checksum of a second application program currently executed on the upper-level layer;
comparing the first application program with the second application program, copying the first application program to a memory in case the first and second application programs are identical to each other, and executing the first application program; and
requesting a download of the second application program to the upper-level layer in case the first and second application programs are different from each other, storing the second application program downloaded from the upper-level layer in the flash ROM, and executing the second application program.

2. A method for storing and executing an application program in a flash ROM, comprising the steps of:
initializing hardware drivers after booting an operating system (OS) stored in one of two partitioned regions of the flash ROM;
reading version and checksum of a first application program stored in the other region of the two partitioned regions;
copying the first application program to a memory;
executing the first application program copied to the memory;
verifying version and checksum of a second application program currently executed in an upper-level layer in hierarchy,
comparing the second application program with the first application program;
performing a normal operation in case the first and second application programs are identical to each other; and
requesting a download of the second application program in case the first and second application programs are different from each other, storing the downloaded second application program in the flash ROM, and transiting to a rebooting sate.
